(19) United States
(12) Patent Application Publication
(10) Pub. No.: US 2025/0369815 A1
(43) Pub. Date: Dec. 4, 2025

(54) SECURE MEASUREMENT SYSTEM AND METHOD FOR DISPLAYING AND TRANSMITTING INTEGRATED DATA

(71) Applicants: AIRBUS HELICOPTERS, Marignane Cedex (FR); J.P.B SYSTEME, Montereau-Sur-Le-Jard (FR)

(72) Inventors: Stéphane BAILLY, Cabries (FR); Georges DEVILLIERS, Marseille (FR); Brieuc BADIN, Thomery (FR); Jonathan BEAUMEL, Vaires Sur Marne (FR)

(73) Assignees: AIRBUS HELICOPTERS, Marignane Cedex (FR); J.P.B SYSTEME, Montereau-Sur-Le-Jard (FR)

(21) Appl. No.: 19/224,115

(22) Filed: May 30, 2025

(30) Foreign Application Priority Data
May 31, 2024 (FR) FR2405661

(51) Int. Cl. G01L 5/24; G01L 3/10

(52) U.S. Cl. CPC G01L 5/243; G01L 3/10

(57) ABSTRACT

A measurement system comprising a sensor and a controller configured to communicate with the sensor, the controller comprising a display. The sensor comprises at least two measurement assemblies and at least one processing circuit connected to one or more sensing elements each measuring a current value of the same parameter. Each processing circuit emits to the controller a measurement signal as a function of the current value measured by the one or more sensing elements and of a stored reference value. The controller is configured: i) to transmit the reference value to each processing circuit that stores it if the reference value is equal to within a margin of the measured current value, and ii) to receive the measurement signals and display respective symbols on the display, the symbols being at least dissimilar or displayed alternately.

### CROSS REFERENCE TO RELATED APPLICATION

This application claims priority to French patent application No. 24 05661 filed on May 31, 2024, the disclosure of which is incorporated in its entirety by reference herein.

### TECHNICAL FIELD

The present disclosure relates to a secure measurement system and method, for displaying and transmitting integrated data.

### BACKGROUND

A measurement system may comprise sensor in communication with a remote controller. The sensor emits a measurement signal representing the current value of a parameter. The remote controller receives the measurement signal, decodes it and displays information representative of the current value of the parameter. The remote controller may also transmit data to the sensor.

In particular, a bolted joint may comprise two mechanical parts tightened against each other using a screw/nut system provided with a threaded portion, a nut and a washer. In use, the threaded portion and the nut may loosen, for example in the presence of vibrations, due to environmental conditions, or even due to wear of the tightened assembly.

In order to limit the risk of loosening, the nut may be in the form of a lock nut cooperating with a lock element. In another example, a lock washer is used. Regardless of the variant, when assembling the mechanical parts, an operator screws the nut on the threaded rod by applying a predetermined nominal tightening torque using a torque wrench. If required, the operator can slightly lower or increase the tightening torque in order to position the lock element. Mastic can also be used.

When critical assemblies are present, regular maintenance actions can take place in order to verify the tightening of the screwing system. The procedure for verifying such tightening may comprise a step of removing any mastic, loosening the screwing system, then a step of retightening to the nominal torque, and optionally a step of applying mastic. Such steps can be difficult, be a source of human error and be time-consuming to perform in a congested and/or difficult-to-access environment, for example within the mechanical system of an aircraft.

According to another technology, a tightening sensor and a controller can be used. Document WO2021/104679 A1 thus describes an instrumented washer for determining an axial tightening load. The instrumented washer comprises an annular washer body. At least one strain gauge is disposed on an outer circumferential side wall of the washer body. This strain gauge is configured to detect deformation of the washer body due to tightening forces. The instrumented washer further comprises a communication assembly operatively connected to the at least one strain gauge. The communication assembly may comprise an integrated circuit suitable for receiving electrical signals from the one or more strain gauges. The one or more received electrical signals may be converted, by the integrated circuit or by an external device, into a signal carrying an axial tightening load of the screwing system.

Thus, an instrumented washer of this type can form a sensor measuring a mechanical tension. This sensor then communicates with an external device that displays a piece of tightening information.

Document EP 4357626 A1 describes a control system for controlling tightening of a screwing system. The control system comprises a measurement system provided with an instrumented washer and a controller. In particular, the controller is configured to verify that a measurement made by the instrumented washer is within a compliance range, for example based on a reference value.

Bolted joints are critical for some applications and are therefore monitored regularly. Malfunction, and in particular loss of integrity, of a measurement system evaluating the tightening of such a bolted joint may therefore have a safety impact, for example within a vehicle or even an aircraft. The concept of loss of integrity corresponds to a situation that causes belief that the tightening is acceptable when this is not so. A loss of integrity may be produced by the presence of an erroneous reference value and/or an incorrect measurement. For example, an erroneous reference value may be stored following a malfunction or human error. In another example, a controller may incorrectly decode a measurement signal and/or may have a defective display.

A loss of integrity can be easily detected by a user in the presence of the display of an aberrant measurement. For example, if the controller indicates that the mechanical tension measured within a bolted joint by an instrumented washer is equal to 50% of its reference value, the user can deduce the presence of a possible malfunction since the measurement normally changes little over time. In this type of situation, the user considers that the data is potentially incorrect or that the tightening is lost. Said user can then use conventional means, such as a torque wrench, to verify the actual condition of the assembly being examined.

On the other hand, it may be difficult to identify a loss of integrity. By way of example, if the value returned by a controller is equal to 99% of the reference mechanical tension while the required tightening torque is no longer applied, then the measurement system is returning an erroneous but plausible datum. The user may be deceived because the information is as expected.

Documents US 2022/308951 A1, US 2022/319342 A1, US 2018/223891 A1, US 2015/247745 A1, and US 2012/191378 A1 are also known.

### SUMMARY

An object of the present disclosure is thus to propose a measurement method and system for limiting the occurrence of the display of erroneous information.

The disclosure thus aims for a measurement system comprising a sensor and a controller configured to communicate with the sensor, the controller comprising a display.

The sensor comprises at least two measurement assemblies and at least one processing circuit, each measurement assembly comprising one or more sensing elements, said at least one processing circuit being connected to said at least one sensing element of each measurement assembly, said at least one processing circuit determining a current value of the same parameter for each measurement assembly from primary signals emitted by the sensing elements of the measurement assemblies, said at least one processing circuit being configured to emit to the controller one measurement signal per measurement assembly as a function of said current measured value determined using the one or more sensing elements of this measurement assembly and of a stored reference value,

The controller is configured:
i) to transmit the reference value to said at least one processing circuit during a single initialization phase, said at least one processing circuit having a memory configured to store the reference value only if the reference value is equal to within a margin of the current values; and
ii) to receive the measurement signals and display respective symbols on the display during a measurement phase, each symbol being a function of the respective measurement signal, the symbols being at least dissimilar or displayed alternately.

The expression “the symbols being at least dissimilar or displayed alternately” means that the symbols are dissimilar and/or are displayed alternately.

The sensor therefore comprises at least a first measurement assembly and a second measurement assembly. The first measurement assembly communicates with a processing circuit, that is specific to it or common with the other measurement assembly, connected by a wired or wireless link to at least one first sensing element. Similarly, the second measurement assembly communicates with a processing circuit, that is specific to it or common with the other measurement assembly, connected by a wired or wireless link to at least one second sensing element. Each of these sensing elements measures a current value of the same parameter. For example, each sensing element comprises a gauge bridge for measuring a mechanical tension, the electrical resistance of the sensing element varying as a function of this mechanical tension. The one or more processing circuits may then comprise a computer, generating a measurement signal as a function of a measurement from the one or more sensing elements and a reference value. The term “computer” is to be interpreted in the broad sense as being a unit capable of executing instructions, a computer being able, for example, to comprise a microcontroller or a microprocessor or even other components. In addition, the sensor comprises at least one transceiver such as an antenna in the context of a wireless transmission or a connector in the context of a wired transmission.

The controller of the measurement system, that is provided with a display, then communicates via a wired or wireless link with the sensor.

In addition, several embodiments of the disclosure relating to a measurement system are envisaged as a function of the number and/or nature of the one or more processing circuits.

According to a first embodiment of the disclosure, the sensor may comprise a single processing circuit connected to each sensing element, this processing circuit implementing at least two dissimilar internal processes to generate at least two said measurement signals, and wherein during the initialization phase the processing circuit may be configured to store the reference value only if the reference value is equal to within a margin of each current value.

For example, the single processing circuit may receive primary signals emitted by sensing elements, such as gauge bridges respectively having different resistances. An offset is then implemented by the processing circuit by means of reception amplifiers. The measurement signals are then emitted to the controller and then a dissimilar coding is implemented in the controller for each processing carried out by the processing circuit.

According to a second embodiment of the disclosure, the sensor may comprises at least two processing circuits and two respective measurement assemblies, each processing circuit being connected to at least one sensing element of the respective measurement assembly and generating one of said measurement signals as a function of the current value measured by said at least one sensing element of the respective measurement assembly and of a reference value stored by this processing circuit, and during the initialization phase, each processing circuit is configured to store the reference value only if the reference value is equal to within a margin of the current value determined by this processing circuit.

For example, the sensor is an instrumented washer configured to be arranged within a bolted joint, said measured parameter being a mechanical tension representing a tightening torque.

During an initialization phase, an operator using a dedicated interface enters the reference value on the controller, that transmits it to the single processing circuit in the case of the first variant or to each processing circuit in the case of the second embodiment of the disclosure. The one or more processing circuits store this reference value only if it is equal to within a margin of the current value or values determined by the one or more processing circuits.

The storage of the reference value is important, since the current values subsequently measured during the measurement phases are compared with this reference value. However, human error is unfortunately possible.

As part of a bolted joint, the operator enters the reference value and tightens the bolted joint with a torque wrench to the desired tightening torque, the applied tightening torque having a direct connection with the measured mechanical tension. This connection depends for example on the pitch of the thread, the effective diameter, the average radius of support under the rotating part, and the coefficient of friction. The or each processing circuit then compares the measured mechanical tension with the reference value that takes the form of a reference mechanical tension. The reference value will only be recorded by the or each processing circuit if the current value that it measures corresponds to the expected reference value, to within measurement uncertainties. Otherwise, a processing circuit can transmit an error signal to the controller to signal this to the operator. Thus, the controller cannot trigger the recording of an erroneous reference value, that effectively secures the system. Similarly, an incorrect adjustment of the torque wrench will also be detected by not allowing the reference value to be stored. The torque applied with the torque wrench, expressed in newton-meters (Nm), and the mechanical tension, expressed in decanewtons (daN) are linked by the physical characteristics of the joint, but have different values and units; this makes it possible to very significantly reduce the risk of human error, as well as of the incorrect adjustment of the wrench.

Moreover, during the measurement phase, the one or more processing circuits generate one measurement signal per measurement assembly. In the first embodiment, the single processing circuit generates said measurement signals. According to the second embodiment and in the presence of two measurement assemblies, the first processing circuit and the second processing circuit emit, to the controller, a first measurement signal and a second measurement signal, respectively. Each measurement signal is a function of the current value measured by the processing circuit concerned and of the reference value stored by this same processing circuit, or of a common value consolidated by the two processing circuits. For example, each measurement signal may carry the current value measured by the corresponding processing circuit, in the form of a percentage of the reference value.

The controller then displays a first symbol illustrating the first measurement transmitted by the first measurement assembly and a second symbol illustrating the second measurement transmitted by the second measurement assembly.

The method implemented in the controller considers the sensor to be high-integrity equipment. The data transmitted by the sensor is either consistent and accurate, or different and not valid. For example, the sensing elements of the measurement assemblies can be adjusted differently and can be compared. By way of illustration, for the same mechanical tension within a bolted joint, the first sensing element of the first measurement assembly may generate an electrical voltage of 3 volts and the second sensing element of the second measurement assembly may generate an electrical voltage of 4 volts. The one or more processing circuits can compare the consistency of the measurements and generate an alert if necessary.

The case of consistent but false data, corresponding to a loss of sensor integrity, is therefore excluded due to security mechanisms and in particular through the use of two separate and independent measurement assemblies. A cyclic redundancy check generated using different generator polynomials may also be undertaken to secure the storage and/or transmission of measurements.

After processing, the controller decodes each measurement signal using the appropriate algorithm and then displays the corresponding symbols. The symbols are displayed differently i. e., in a plurality of different formats and/or in a plurality of different places on the display and/or at different times. The system works normally if the symbols correspond to one another. Conversely, if the data from the two measurement assemblies are different, or if the controller malfunctions, display inconsistencies appear in a manner that is obvious to the operator.

Thus, a measurement system according to the disclosure makes it possible, firstly, to secure the entry of a reference value during the initialization phase and, secondly, to consolidate the measurements transmitted and displayed during a measurement phase. Such a measurement system thus limits, firstly, the occurrence of the display of non-integrated data, also called “erroneous data”, and secondly the occurrence of storage of an incorrect reference value that would falsify subsequent readings.

The measurement system may, in addition, comprise one or more of the following features, taken individually or in combination.

According to one possibility, the measurement signals may be coded differently.

To ensure the integrity of the sensor, the one or more processing circuits may encode the measurement signals differently. Thus, a first processing circuit may encode the value determined using the measurement of the first sensing element or elements and the reference value, that it stores in binary, while a second processing circuit encodes the value determined using the measurement of the second sensing element or elements and the reference value, that it stores in binary with a complement of 2.

According to one display possibility, said symbols may comprise a first symbol that comprises a number displayed in numerical form and a second symbol carrying a number displayed in alphabetic form.

For example, the first symbol is the number “11” while the second symbol is the word “eleven”. The first symbol and the second symbol therefore carry the same information under these conditions. A user visually observes that the measurement system is working correctly. On the other hand, if the first symbol is the number “15” while the second symbol is the word “eleven”, the operator visually observes s that the measurement system is malfunctioning.

This possibility therefore enables a user to easily and quickly identify whether the measurement system is working correctly.

According to one display possibility, said symbols may comprise a first symbol and a second symbol presented in the same form, said form being either numerical form or alphabetic form or graphic form, the first symbol and the second symbol being displayed alternately at the same position on the display.

When the measurement system is functioning correctly, the user will see a stable symbol. Conversely, in the event of malfunction, the user will see two different symbols superimposed and unstable.

For example, the first symbol and the second symbol are of different colors, or even are displayed at a high frequency, for example, greater than 18 Hertz (Hz).

In the absence of malfunction, the user must observe a color corresponding to the synthesis of the colors of the symbols, due to the phenomenon of retinal afterglow. Otherwise, the information will be considered as invalid by the operator.

Optionally, the expected color may be displayed on the display by the controller for comparison.

A similar result can be achieved by using various colors and particular transparency levels. These different methods can be combined.

According to one display possibility, said symbols may comprise a first symbol displaying the associated current value in the form of a percentage of the associated reference value written numerically or alphabetically, the second symbol comprising a scale and an indicator pointing on the scale to the associated current value in the form of a percentage of the associated reference value.

The term “scale” is to be interpreted in the broad sense, and refers to a symbol extending from an origin to a point illustrating the reference value. For example, the scale and indicator can form a so-called “pie chart”. Alternatively, the scale may also take the form of a band filled from the origin to the indicator finger, or alternatively take the form of a scale per se, graduated or otherwise, for example.

This possibility therefore enables a user to easily and quickly identify whether the measurement system is working correctly.

In addition, this variant may offer the possibility of using data of an entirely different nature from the measurements, in order to increase the level of security.

Indeed, the controller may be configured to transmit to said at least one processing circuit controlling the second symbol, the coordinates on the display of a start pixel and of an end pixel of said scale, the measurement signals emitted by said at least one processing circuit carrying the coordinates of said indicator on the display, said at least one processing circuit being configured to determine said coordinates of said indicator as a function of the start pixel, the end pixel, the reference value stored in said at least one processing circuit and the current value determined for each measurement assembly.

The processing circuit concerned is thus configured to apply a stored law giving the coordinates of said indicator as a function of the start pixel, the end pixel, the reference value, and the one or more measurements of the one or more associated sensors.

The numerical and graphical natures of the same data in the form of numbers and pixel coordinates are fundamentally different. The occurrence of a malfunction able to affect these two dissimilar pieces of information in the same way is not realistic, which enables the system to be secured. The processing circuit and the controller do not know the link between these two formats (digital, and analog scale). Conversely, the operator can easily verify the consistency of all the information displayed.

According to one possibility compatible with the preceding possibilities, if the reference value is not equal to within a margin of the current value determined by said at least one processing circuit, this or these one or more processing circuits may be configured not to store the reference value and to transmit an alert signal during the initialization phase.

The storage of the reference value then ensures the smooth conduct of the initialization phase, and the initial tightening phase in the case of an instrumented washer.

According to one possibility compatible with the preceding possibilities, during the initialization phase, the controller and the sensor can be configured to implement an interactive verification phase comprising a human operation of at least one interface of the controller, the one or more processing circuits being configured to store said reference value as a function of an outcome of the interactive verification phase.

This interactive phase prohibits the recording of the reference value in the event of human error, or when the controller is not operating correctly.

For example, during the interactive verification phase, said at least one processing circuit can be configured to transmit polar coordinates to the controller with respect to a reference frame of the display, the controller being configured to display, on the display, a cursor at a predetermined position, for example at the center of a reference frame, and a confirmation area, a reference point of the confirmation area having polar coordinates as coordinates in the reference frame, the controller having a man-machine interface for moving the cursor in two orthogonal directions by movement increments in order to allow a user to place the cursor in the confirmation area, the controller having a man-machine interface for confirmation, the controller being configured following a request from the man-machine interface for transmitting to the sensor two numbers of movement increments respectively in the two directions, said at least one processing circuit being configured to confirm the storage if the two numbers of increments correspond to the polar coordinates according to a stored law.

In the presence of a plurality of processing circuits, one of the predetermined processing circuits may be configured to implement this phase.

This feature can ensure that a recording of the reference value is actually requested by an operator. The sensor verifies the consistency between the movement of the cursor and the requested location of the confirmation area. The two values of the displacement increments, according to the two directions respectively, result from an act of the operator performed by graphically interpreting the displayed information, and cannot be the result of a failure/error of the controller.

In addition to a measurement system, the disclosure also relates to a vehicle comprising this measurement system.

In addition to a measurement system, the disclosure relates to a measurement method comprising the various steps implemented by the aforementioned system.

Thus, a measurement method is provided for measuring a parameter, using a sensor and a controller configured to communicate with the sensor, the controller comprising a display.

The sensor comprises at least two measurement assemblies and at least one processing circuit, each measurement assembly comprising one or more sensing elements, said at least one processing circuit being connected to said at least one sensing element of each measurement assembly, said at least one processing circuit determining a current value of the same parameter for each measurement assembly from primary signals emitted by the sensing elements of the measurement assemblies, said at least one processing circuit being configured to emit to the controller one measurement signal per measurement assembly as a function of said current value determined using the one or more sensing elements of this measurement assembly and of a stored reference value,

Such a method comprises the following steps:
i) during an initialization phase, transmitting using the controller said reference value to said at least one processing circuit of the sensor, and for said at least one processing circuit: storing in a memory of said at least one processing circuit, the reference value only if the reference value is equal to within a margin of the current values; and
ii) during a measurement phase, emitting of the measurement signals by said at least one processing circuit and receiving of the measurement signals by the controller, then displaying on the display at least one symbol per measurement signal, each symbol being a function of the respective measurement signal, the symbols being at least dissimilar displayed alternately.

The method may also comprise the steps previously described in the context of the description of the measurement system.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating an initialization phase carried out using a measurement system according to a first embodiment of the disclosure;

FIG. 2 is a diagram illustrating an initialization phase carried out using a measurement system according to a second embodiment of the disclosure;

FIG. 3 is a diagram illustrating a measurement phase carried out using a measurement system according to the second embodiment of the disclosure;

FIG. 4 is a diagram illustrating a measurement phase carried out using a measurement system according to the second embodiment of the disclosure;

FIG. 5 is a diagram illustrating a measurement phase carried out using a measurement system according to the second embodiment of the disclosure; and

FIG. 6 shows a view of a measurement system according to the disclosure arranged within a bolted joint of a vehicle.

### DETAILED DESCRIPTION

Elements present in more than one of the figures are given the same references in each of them.

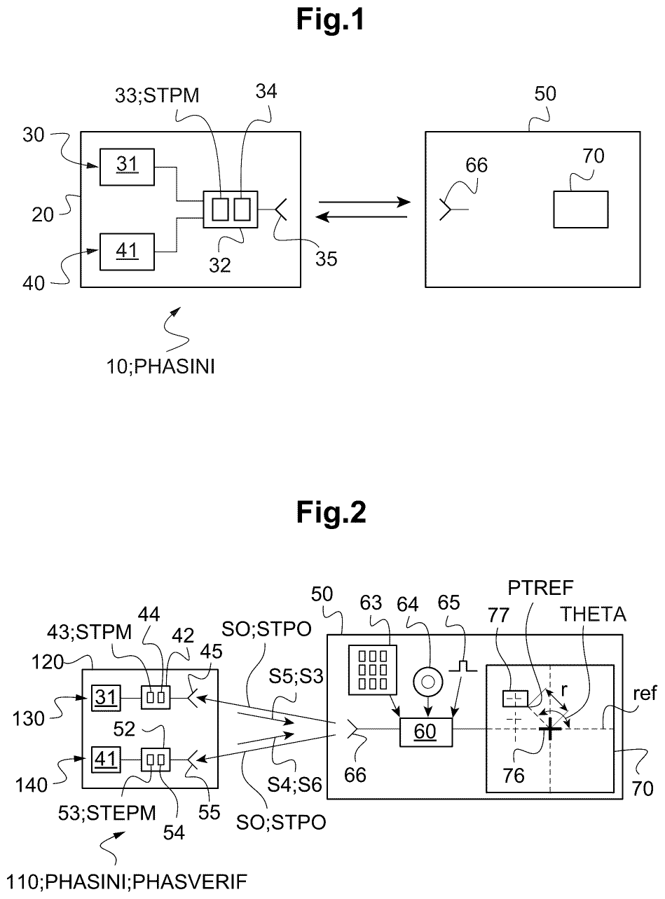

FIG. 1 shows a measurement system 10 according to a first embodiment of the disclosure. This measurement system 10 comprises a sensor 20, and a controller 50 configured to communicate with the sensor 20.

In particular, the sensor 20 comprises at least two measurement assemblies 30, 40. The sensor 20 comprises a single processing circuit 32 connected to the sensing elements 31, 41, the various sensing elements 31, 41 each enabling a current value of the same parameter to be measured. The sensing elements 31, 41 may be carried by the same support, for example in an instrumented washer, a screw head or the like. The processing circuit 32 may be offset with respect to the sensing elements, or may also be carried by the support.

For example, each sensing element 31, 41 may comprise a strain gauge for evaluating a deformation of a support in one direction.

In particular, the sensor 20 may be a mechanical tension sensor, each sensing element 31, 41 having a strain gauge generating an electrical voltage varying with the mechanical tension within a bolted joint. In this case, the sensor 20 may comprise one or more elements of the system described in document WO2021/104679 A1. For example, the sensor 20 comprises an annular body, each measurement assembly 30, 40 having at least one strain gauge disposed on an outer circumferential side wall of the washer body. The processing circuit 32 receives an electrical signal from the one or more strain gauges of its measurement assembly, and converts it into a signal carrying a mechanical tension.

The disclosure is, nevertheless, applicable to any type of sensors.

The processing circuit 32 comprises a computer 34 and a memory 33 for storing at least one reference value. The computer 34 is in particular configured, for example by executing instructions stored in the memory 33: a) to calculate, for each measurement assembly, a current value of the parameter measured from the signal or signals emitted by the one or more sensing elements 31, 41 of this measurement assembly; b) to store, during an initialization phase described below, the reference value in the memory 33 of the processing circuit 32 under predetermined conditions and as a function of the current values determined; and c) to generate one measurement signal per measurement assembly during a measurement phase.

The computer 34 may comprise, for example, at least one processor and at least one memory, at least one integrated circuit, at least one programmable system, or at least one logic circuit, these examples not limiting the scope to be given to the term “processing unit”. The term “processor” may refer equally to a central processing unit (CPU), a graphics processing unit (GPU), a digital signal processor (DSP), a microcontroller, etc. The processing circuit 32 may comprise, for example, a microcontroller provided with a computer 34 and a memory 33.

The processing circuit 32 is also connected to a transceiver 35 capable of communicating with the controller 50. Such a transceiver 35 may comprise, for example, an antenna in the context of a wireless link, or a connector. The processing circuit 32 can communicate with its own transceiver 35 according to the example illustrated, capable of communicating with a transceiver 66 of the controller 50.

The measurement assemblies 30, 40 may further comprise an electrical power source. Alternatively, the measurement assemblies 30, 40 may be electrically powered by the controller 50, for example through a radio frequency identification (RFID) system.

FIG. 2 shows a measurement system 110 according to a second embodiment of the disclosure. This measurement system 110 comprises a sensor 120, and a controller 50 configured to communicate with the sensor 120.

In particular, the sensor 120 comprises at least two measurement assemblies 130, 140. Each measurement assembly 130, 140 communicates with its own processing circuit 42, 52 connected to its own sensor or sensing elements 31, 41, the various sensing elements 31, 41 each making it possible to measure a current value of the same parameter.

Furthermore, each processing circuit 42, 52 comprises a computer 44, 54 and a memory 43, 53 for storing at least one reference value. Each computer 44, 54 is in particular configured, for example by executing instructions stored in the memory 43, 53: a) to calculate a current value of the measured parameter from the signal or signals emitted by the one or more sensing elements 31, 41 of its measurement assembly; b) to store, during an initialization phase described below, the reference value in the memory 43, 53 of the processing circuit 42, 52 under predetermined conditions and as a function of the current value determined; and c) to generate a measurement signal during a measurement phase.

Each computer 44, 54 may comprise, for example, at least one processor and at least one memory, at least one integrated circuit, at least one programmable system, or at least one logic circuit, these examples not limiting the scope to be given to the term “computer”.

In this case, independently of the nature of the sensing elements 31, 41, the sensor 120 therefore comprises a first measurement assembly 130 comprising one or more first sensing elements 31 in communication via a wired or wireless link with a first processing circuit 42 connected to a first transceiver 45, as well as a second measurement assembly 140 comprising one or more second sensing elements 41 in communication via a wired or wireless link with a second processing circuit 52 connected to a second transceiver 55, it being possible for the first and second transceivers 45, 55 to be separate or to form a single transceiver for communicating with the controller 50.

Irrespective of the embodiment, the controller 50 comprises at least one display 70. The display 70 is controlled by a manager 60 connected to a transceiver 66. The manager 60 may comprise, for example, at least one processor and at least one memory, at least one integrated circuit, at least one programmable system, or at least one logic circuit, these examples not limiting the scope to be given to the term “manager”. The term “processor” may be used equally well to mean a central processing unit (CPU), a graphics processing unit (GPU), a digital signal processor (DSP), a microcontroller, etc.

The manager 60 is configured to perform predetermined actions, for example by applying stored instructions. The function of the manager 60 is, in particular, to control the sensor 120 if necessary and to process the measurement signals transmitted by the sensor 120.

To this end, the manager 60 is connected by a wired or wireless link to a transmitter/receiver 66 capable of communicating with the sensor 120. In addition, the manager 60 is connected via a wired or wireless link to one or more human-machine interfaces 63, 64, 65.

For example, the manager 60 is connected by a wired or wireless link to a human-machine input interface 63 for inputting a reference value. For example, such an interface may be in the form of a keyboard, a touch-sensitive member, or the like.

For example, the manager 60 is connected via a wired or wireless link to a movement man-machine interface 64 to request the movement of a cursor on the display 70. By way of illustration, such an interface may take the form of a button rotating about two axes, a plurality of buttons, etc.

For example, the manager 60 is connected via a wired or wireless link to a confirmation human-machine interface 65 in order to confirm an action. By way of illustration, such an interface may take the form of a push button, a touch panel, etc.

As illustrated in FIG. 2, the controller 50 is configured to transmit the reference value to each processing circuit 42, 52, each processing circuit 42, 52 being configured to store the reference value in its memory 43, 53 only if this reference value is equal, within a margin, to the measured current value.

Thus, an operator can parameterize the reference value by invoking the input man-machine interface 63. This input man-machine interface 63 transmits a signal to the manager 60 that emits a parameterization signal S0 carrying the reference value input by means of the transmitter/receiver 66.

Each processing circuit 42, 52 receives this parameterization signal S0 and decodes it. In parallel, each processing circuit 42, 52 determines the current value of the parameter measured by the sensor or sensing elements 31, 41 of its measurement assembly. Consequently, each processing circuit 42, 52 stores the reference value when this reference value is equal to the determined current value, plus or minus a predetermined margin. Thus, each processing circuit 42, 52 stores the reference value. Therefore, any controller will be able to implement a measurement phase thereafter.

Optionally, each processing circuit 42, 52 returns a confirmation signal S3, S4, the manager 60 being able to receive and decode this confirmation signal in order to display, on the display 70, a symbology indicating that the storage has been carried out.

Otherwise, a processing circuit 42, 52 can return an alert signal S5, S6, the manager 60 being able to receive and decode this alert signal to display an alert on the display 70.

According to the embodiment of FIG. 1, the controller 50 is configured to transmit the reference value to the single processing circuit, this processing circuit being configured to store the reference value in its memory, only if this reference value is equal to within a margin of the current values determined respectively with the measurement assemblies. For this purpose, the processing circuit receives the parameterization signal S0 and decodes it. In parallel, the processing circuit determines, for each measurement assembly, the current value of the parameter measured by the one or more sensing elements 31, 41 of this measurement assembly. Consequently, the processing circuit stores the reference value when this reference value is equal to each determined current value, plus or minus a predetermined margin. Optionally, the processing circuit returns a confirmation signal, the manager 60 being able to receive and decode this confirmation signal in order to display, on the display 70, a symbology indicating that the storage has been carried out. Otherwise, the processing circuit can return an alert signal, the manager 60 being able to receive and decode this alert signal to display an alert on the display 70.

Regardless of the embodiment, before storage, the controller 50 and the sensor 120 can be configured to implement an interactive verification phase PHASVERIF requiring human intervention. The one or more processing circuits are configured to store the reference value only as a function of a positive outcome of the interactive verification phase PHASVERIF.

For example, and according to the second embodiment, during the interactive verification phase PHASVERIF, the first processing circuit 42 is configured to transmit polar coordinates (r, theta) to the controller 50. The manager 60 then drives the display 70 in order to display a cursor 76 at a predetermined position, for example at the center of a two-dimensional reference frame, ref. In addition, the manager 60 is configured to control the display of a confirmation area 77 at the location required by said polar coordinates. For example, a reference point PTREF of the confirmation area 77 has said polar coordinates as coordinates in the reference frame, ref. According to the example given, a corner of a rectangular confirmation area represents this reference point PTREF.

The operator then uses the man-machine interface 64 to move the cursor 76 in two orthogonal directions, namely in four up/down/left/right directions, in movement increments, in order to move the cursor 76 in the confirmation area 77. The cursor 76 is moved, according to the illustrated example, by one increment to the left and then by two increments upwards, the successive positions of the cursor 76 being illustrated by dotted lines. The manager 60 then transmits a movement signal carrying the two numbers of movement increments in the two directions respectively, i.e., one increment to the left and two upward increments in the example given. Each processing circuit 42, 52 is configured to confirm the storage of the reference value if the two numbers of increments correspond to the polar coordinates according to a stored law. For example, the first processing circuit 42 performs this verification and informs the second processing circuit 52 thereof. In case of inconsistency, a processing circuit may issue an alert signal to the controller that as a consequence generates an alert.

In the first embodiment, the single processing circuit performs the aforementioned steps.

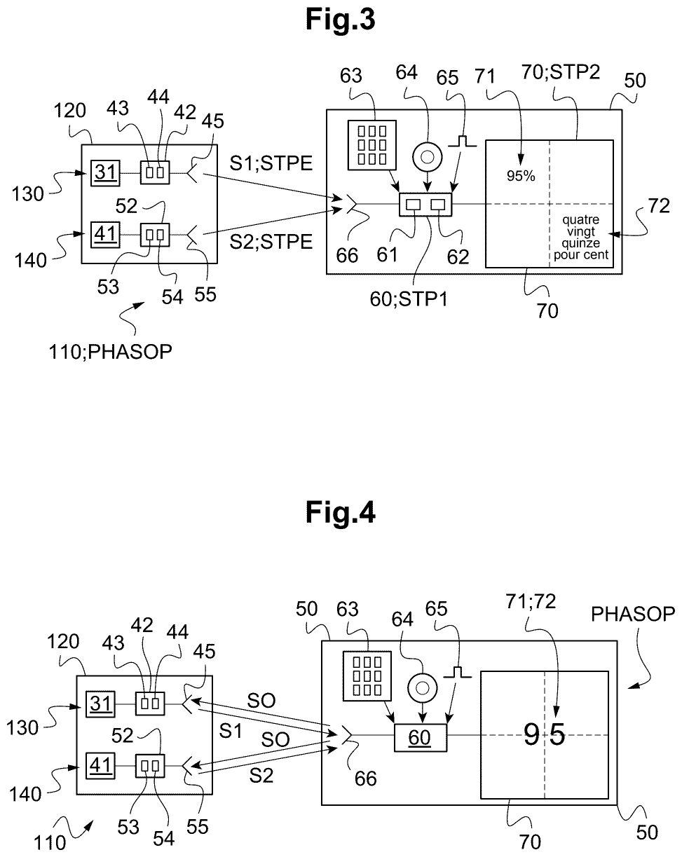

According to another aspect of the measurement system 110 and with reference to FIG. 3, during a measurement phase, each processing circuit 42, 52 encodes a measurement signal S1, S2. For example, the measurement signals S1, S2 are coded differently.

In the first embodiment, only the single processing circuit performs these actions.

Optionally, each measurement signal S1, S2 carries the measured current value, for example in the form of a percentage of the reference value.

The controller 50 is configured to receive, during a step STP1, the measurement signals S1, S2 emitted by the processing circuits 42, 52. The manager 60 decodes these and, during a step STP2, drives the display of the respective symbols 71, 72 on the display 70. Thus, a first symbol 71 carries the current value measured by the first measurement assembly 130, and a second symbol carries the current value measured by the second measurement assembly 140. Each symbol 71, 72 is therefore a function of the respective measurement signal S1, S2.

Moreover, the symbols 71, 72 are dissimilar and/or displayed alternately in the same place on the display 70 to allow an operator to visually detect a malfunction. The symbols 71, 72 may be displayed in various forms.

In the first variant of FIG. 3, the first symbol 71 and the second symbol 72 present a value in numerical form and in alphabetic form, respectively. In particular, the first symbol 71 and the second symbol 72 may present the current value as a percentage of the reference value. In particular, the first symbol 71 takes the form of a number displayed in numerical form, while the second symbol takes the form of a sequence of letters.

According to the second variant of FIG. 4, the first symbol 71 and the second symbol 72 are presented in the same form. The first symbol 71 and the second symbol 72 may jointly take either a numerical form according to the example illustrated, or an alphabetic form or a graphical form. The first symbol 71 and the second symbol 72 are, in addition, displayed alternately at the same position on the display 70.

According to the example given, if the first symbol 71 and the second symbol 72 comprise the number 95, the display will be stable. On the other hand, if the first symbol comprises the number 95 and the second symbol comprises a different number, the number 50 for example, the operator will visually notice the presence of a malfunction.

Moreover, the first connecting symbol 71 and the second symbol 72 may be of different colors.

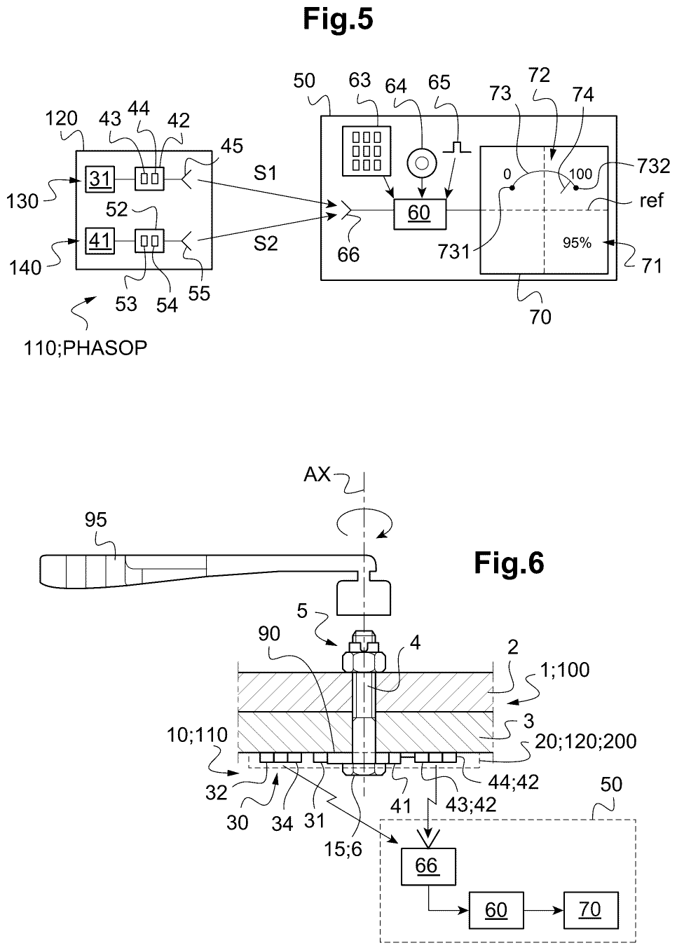

According to the third variant of FIG. 5, the first symbol 71 may display the measured current value in the form of a percentage of the associated reference value written numerically or alphabetically. On the other hand, the second symbol 72 comprises a graph. Such a graph is provided with a scale 73 and an indicator 74 pointing on the scale 73 to the current value measured in the form of a percentage of the associated reference value.

For example, the controller 50, and optionally the manager 60, are configured to transmit to the second processing circuit 52 the coordinates on the display 70 of a start pixel 731 and an end pixel 732 of the scale 73. The second processing circuit 52, or the single processing circuit according to the first embodiment, is then configured to calculate the coordinates of the indicator 74, as a function of the coordinates of the start pixel 731 and of the end pixel 732, of the measured current value and the stored reference value. For this purpose, the second processing circuit may comprise a stored mathematical law providing the coordinates of the indicator 74. The second processing circuit 52 is then configured to generate a second measurement signal S2 carrying the calculated coordinates of the indicator 74. The manager 60 receives it and accordingly drives the display of the indicator 74.

The controller 50 may optionally comprise a human-machine selection interface for switching from one variant to another in order to reinforce the operator's diagnosis.

Whatever the embodiment and variant of the disclosure, such a measurement system 10, 110 can limit the risks of being confronted with an undetectable failure, by securing the storage of the reference value during the initialization phase, while securing the display of information during a measurement phase.

Optionally, such a measurement system 10, 110 may be arranged on any mechanical assembly such as rails with railway sleepers, a chassis for a ride or roller coaster, a vehicle, or even in particular an aircraft.

More precisely, FIG. 6 illustrates the possibility of arranging such a measurement system 10, 110 within a bolted joint 1.

Such a bolted joint 1 may comprise at least two mechanical parts 2, 3 to be tightened against each other. A screwing system may be used to tighten an assembly 1. The screwing system is provided with a threaded section 4 having a male thread to be screwed to a female thread of at least one nut 5.

According to the illustrated example, the threaded portion 4 may be integral with a screw head 6 in order to form a screw 15. According to other examples, the threaded portion 4 may be screwed to two nuts or may be integral with one of the mechanical parts 2, 3 to be tightened.

The screwing system may also comprise locking means.

According to the illustrated example, the nut 5 is a slotted nut cooperating with a pin passing through the threaded portion 4.

This bolted joint 1 then comprises the sensor 20, 120 of a measurement system 10, 110 according to the disclosure, to evaluate a mechanical tension representing a tightening torque of the bolted joint 1. For example, the sensor 20, 120 is arranged within an instrumented washer. For example, the instrumented washer may be tightened between the head 6 integral with the threaded portion 4 and the part 3.

The instrumented washer may in particular comprise a washer body 90 through which the threaded portion 4 passes. This washer body 90 can carry the sensing elements 31, 41. For example, each sensing element 31, 41 is disposed on an outer circumferential side wall of the washer body 90. Each sensing element 31, 41 may comprise a strain gauge configured to provide a signal that varies as a function of deformation of the washer body 90 due to the tightening forces.

During the initialization phase, the operator tightens the nut 5 to the required tightening torque using a torque wrench 95. Moreover, the operator inputs the reference value using the controller 50. If the current values generated from the sensing elements 31, 41 do not correspond to the reference value, the initialization phase fails. The storage of the reference value is not performed, and an alert can be generated.

During a measurement phase, the operator reads the current value measured by the measurement assemblies 30, 40 using a controller 50. Depending on the symbols 71, 72 displayed, the operator can deduce the possible presence of a malfunction of the measurement system 10, 110. Otherwise, the operator can determine whether the bolted joint 1 is still correctly tightened.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A measurement system comprising a sensor and a controller configured to communicate with the sensor, the controller comprising a display, the sensor comprising at least two measurement assemblies and at least one processing circuit, each measurement assembly comprising one or more sensing elements, the at least one processing circuit being connected to the one or more sensing element of each measurement assembly, the at least one processing circuit determining a current value of the same parameter for each measurement assembly from primary signals emitted by the sensing elements of the measurement assemblies, the at least one processing circuit being configured to emit to the controller one measurement signal per measurement assembly as a function of the current value determined using the one or more sensing elements of this measurement assembly and of a stored reference value,
wherein, the controller is configured:
to transmit the reference value to the at least one processing circuit during a single initialization phase, the at least one processing circuit having a memory configured to store the reference value only if the reference value is equal to within a margin of the current values; and
to receive the measurement signals and display respective symbols on the display during a measurement phase, each symbol being a function of the respective measurement signal, the symbols being at least dissimilar or displayed alternately.

2. The measurement system according to claim 1,
wherein the sensor comprises a single processing circuit connected to each sensing element, the processing circuit implementing at least two dissimilar internal processes to generate at least two so-called measurement signals, and wherein during the initialization phase the processing circuit is configured to store the reference value only if the reference value is equal to within a margin of each current value.

3. The measurement system according to claim 1,
wherein the sensor comprises at least two processing circuits and two respective measurement assemblies, each processing circuit being connected to at least one sensing element of the respective measurement assembly and generating one of the measurement signals as a function of the current value measured by the at least one sensing element of the respective measurement assembly and of a reference value stored by this processing circuit, and wherein during the initialization phase, each processing circuit is configured to store the reference value only if the reference value is equal to within a margin of the current value determined by this processing circuit.

4. The measurement system according to claim 1,
wherein the sensor is an instrumented washer configured to be arranged within a bolted joint, the parameter being a mechanical tension representing a tightening torque.

5. The measurement system according to claim 1,
wherein the measurement signals are coded differently.

6. The measurement system according to claim 1,
wherein the symbols comprise a first symbol that comprises a number displayed in numerical form and a second symbol carrying a number displayed in alphabetic form.

7. The measurement system according to claim 1,
wherein the symbols comprise a first symbol and a second symbol presented in the same form, the form being either numerical form or alphabetic form or graphic form, the first symbol and the second symbol being displayed alternately at the same position on the display.

8. The measurement system according to claim 7,
wherein the first symbol and the second symbol are different colors.

9. The measurement system according to claim 1,
wherein the symbols comprise a first symbol displaying the associated current value in the form of a percentage of the associated reference value written numerically or alphabetically, the second symbol comprising a scale and an indicator pointing on the scale to the associated current value in the form of a percentage of the associated reference value.

10. The measurement system according to claim 9,
wherein the controller is configured to transmit, to the at least one processing circuit controlling the second symbol, coordinates on the display of a start pixel and of an end pixel of the scale, the measurement signals emitted by the at least one processing circuit carrying the coordinates of the indicator on the display, the at least one processing circuit being configured to determine the coordinates of the indicator as a function of the start pixel, the end pixel, the reference value stored in the at least one processing circuit and the current value determined for each measurement assembly.

11. The measurement system according to claim 1,
wherein if the reference value is not equal to within a margin of the current value determined by the at least one processing circuit, the at least one processing circuit is configured not to store the reference value and to transmit an alert signal during the initialization phase.

12. The measurement system according to claim 1,
wherein during the initialization phase, the controller and the sensor are configured to implement an interactive verification phase comprising a human operation of at least one interface of the controller, the at least one processing circuit being configured to store the reference value as a function of an outcome of the interactive verification phase.

13. The measurement system according to claim 12,
wherein during the interactive verification phase, the at least one processing circuit is configured to transmit polar coordinates to the controller with respect to a reference frame of the display, the controller being configured to display, on the display, a cursor at a predetermined position and a confirmation area, a reference point of the confirmation area having as coordinates in the reference frame the polar coordinates, the controller having a man-machine interface for moving the cursor in two orthogonal directions by movement increments to allow a user to place the cursor in the confirmation area, the controller having a man-machine interface for confirmation, the controller being configured following a request from the man-machine interface for transmitting, to the sensor, two numbers of movement increments in the two directions respectively, the at least one processing circuit being configured to confirm the storage if the two numbers of increments correspond to the polar coordinates according to a stored law.

14. A vehicle,
wherein the vehicle comprises the measurement system according to claim 1.

15. A measurement method for measuring a parameter with a sensor and a controller configured to communicate with the sensor, the controller comprising a display, the sensor comprising at least two measurement assemblies and at least one processing circuit, each measurement assembly comprising one or more sensing elements, the at least one processing circuit being connected to the one or more sensing element of each measurement assembly, the at least one processing circuit determining a current value of the same parameter for each measurement assembly from primary signal emitted by the at least one sensing element of the measurement assemblies, the at least one processing circuit being configured to emit to the controller one measurement signal per measurement assembly as a function of the current value determined using the one or more sensing elements of this measurement assembly and of a stored reference value,
the method comprising the following steps:
during an initialization phase, transmitting with the controller the reference value to the at least one processing circuit of the sensor, and for the at least one processing circuit: storing in a memory of the at least one processing circuit the reference value only if the reference value is equal to within a margin of the current values; and
during a measurement phase, emitting of the measurement signals by the at least one processing circuit and receiving of the measurement signals by the controller, then displaying on the display at least one symbol per measurement signal, each symbol being a function of the respective measurement signal, the symbols being at least dissimilar or displayed alternately.
